(19) United States
(12) Patent Application Publication
(10) Pub. No.: US 2006/0058573 A1
(43) Pub. Date: Mar. 16, 2006

(54) Method and apparatus for vibrational damping of implantable hearing aid components

(76) Inventors: Johann J. Neisz, Coon Rapids, MN (US); Jason J. Skubitz, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/229,477

(22) Filed: Sep. 16, 2005

Related U.S. Application Data
(60) Provisional application No. 60/610,340, filed on Sep. 16, 2004.

(51) Int. Cl. H04R 25/00

(52) U.S. Cl. 600/25

(57) ABSTRACT

A method and apparatus for minimizing or eliminating the transmission of vibration away from, as well as induction of vibration into, a middle ear driving or sensing structure of an at least partially implantable hearing aid system. A vibration damping intermediary layer may be positioned between an originating structure and its housing, and/or between a housing and its mounting to the surrounding. The intermediary layer may be formed of a structure having elastic and damping characteristics. The intermediary layer may also have a number of fluid flow paths for absorbing energy and damping vibration.

### RELATED APPLICATIONS

This application claims priority from provisional application Ser. No. 60/610,340, filed Sep. 16, 2004, the entire disclosure of which is hereby incorporated by reference.

### FIELD OF THE INVENTION

This invention relates to a hearing aid system that reduces vibrations transmitted and/or absorbed by electromechanical transducers, in particular those systems that are at least partially implantable in a middle ear.

### BACKGROUND

In some types of partial middle ear implantable (P-MEI) or total middle ear implantable (T-MEI) hearing aid systems, sounds produce mechanical vibrations within the ear which are converted by an electromechanical input transducer into electrical signals. These electrical signals are in turn amplified and applied to an electromechanical output transducer. The electromechanical output transducer causes an ossicular bone to vibrate in response to the applied amplified electrical signals, thereby improving hearing.

An electromechanical transducer used for the purpose of vibrating or sensing from any or all elements of the ossicular chain may be mounted in or near the middle ear. The transducer is generally contained in a housing or enclosure, forming a driver or sensor assembly that facilitates the placement of the transducer within the middle ear.

Given the mechanical nature of such driver or sensor assemblies, vibrations may be transmitted into their housing or enclosure. The housing or enclosure can in turn transmit these vibrations to surrounding structures in and around the middle ear, for example, the tissue or bone they are mounted to.

Vibrations that are transmitted from the housing of a driver or sensor assembly into surrounding structures, can in turn be absorbed by the housing of another driver or sensor assembly to produce interference or cross-talk. This interferes with the proper functioning of the driver or sensor assembly, and may result in a feedback problem experienced by some middle ear implant systems.

It is therefore desirable to provide an apparatus that minimizes or eliminates the transmission of vibrations away from the driver or sensor assemblies of middle ear implantable hearing aid systems, and/or prevents induction of vibrations into such structures. It is also desirable to provide a method of mounting driver or sensor assemblies of middle ear implantable hearing aid systems in a way that minimizes or eliminates the transmission or induction of vibrations. It is further desirable to achieve these results in a relatively simple, cost-effective manner.

### SUMMARY OF THE INVENTION

In certain embodiments of the invention, a driver/sensor assembly for a middle ear implantable hearing aid system includes a transducer assembly having a proximal end and a distal end, a housing at the proximal end of the transducer assembly, the housing configured for mounting within a middle ear space, and a first intermediary layer positioned between the transducer assembly and the housing to provide vibrational damping between the housing and the transducer assembly, the intermediary layer including a structure having elastic and vibration damping properties. In certain further embodiments, a plurality of fluid flow paths is provided by the intermediary layer to absorb energy and provide vibrational damping.

In certain other embodiments of the invention, a driver/sensor assembly for a middle ear implantable hearing aid system includes a transducer assembly having a proximal end and a distal end, a housing coupled to the proximal end of the transducer assembly, the housing configured for mounting within a middle ear space, and a first intermediary layer positioned on an outer surface of the housing to provide vibrational damping between the housing and the middle ear space, the intermediary layer including a structure having elastic and vibration damping properties. In certain further embodiments, a plurality of fluid flow paths is provided by the intermediary layer to absorb energy and provide vibrational damping.

In another embodiment of the invention, a method of reducing vibrations in a middle ear implantable hearing aid system includes providing a transducer assembly, providing a housing to support the transducer assembly, the housing configured for mounting within a middle ear space, and forming an intermediary layer on a portion of the housing to provide vibrational damping, the intermediary layer including a structure having elastic and vibration damping properties.

In another embodiment of the invention, a middle ear implantable hearing aid system includes: a driver assembly, the driver assembly having a driver transducer assembly adapted to convert electrical energy to mechanical energy, the driver assembly also having a driver housing configured for mounting within a middle ear space; a sensor assembly, the sensor assembly having a sensor transducer assembly adapted to convert mechanical energy to electrical energy, the sensor assembly also having a sensor housing configured for mounting within a middle ear space; an electronics unit having a sound processor and a battery, the sound processor capable of filtering and amplifying signals from the sensor assembly and providing signals to the driver assembly; and leads coupling the driver and sensor assemblies to the electronics unit, wherein an intermediary layer is disposed on at least one of the sensor housing and driver housing to provide vibrational damping, the intermediary layer comprising a structure having elastic and vibration damping properties. In one aspect, the intermediary layer is positioned between a transducer assembly and a housing to provide vibrational damping between the housing and the transducer assembly. In another aspect, the intermediary layer is positioned on an outer surface of the housing to provide vibrational damping between the housing and the middle ear space.

### DESCRIPTION OF THE DRAWINGS

FIG. 1 illustrates a frontal section of an anatomically normal human right ear.

FIG. 2 is a generalized illustration of a transducer and housing mounted within a middle ear.

FIG. 3 is a generalized illustration of a typical T-MEI hearing aid system, including both driver and sensor assemblies.

FIG. 4 is a perspective view of a T-MEI hearing aid system.

FIG. 5 is a perspective, exploded view of a driver assembly.

FIG. 6 is a schematic illustration of the problem of feedback between sensing and driving structures in a T-MEI hearing aid system.

FIG. 7a is a perspective view of a sensor or driver assembly of a hearing aid system according to an embodiment of the invention.

FIG. 7b is a perspective view of a sensor or driver assembly of a hearing aid system according to another embodiment of the invention.

FIG. 8a is a cross-sectional view of a sensor or driver assembly of a hearing aid system mounted within a middle ear according to an embodiment of the invention.

FIG. 8b is a cross-sectional view of a sensor or driver assembly of a hearing aid system mounted within a middle ear according to another embodiment of the invention.

FIG. 9 is a cross sectional view of a sensor or driver assembly of a hearing aid system mounted within a middle ear according to another embodiment of the invention.

FIG. 10a is a schematic diagram of an intermediary layer having a plurality of flow paths according to an embodiment of the invention.

FIG. 10b is a cross-sectional side view of a driver/sensor assembly with an intermediary layer in accordance with an embodiment of the invention

FIG. 11 is a cross-sectional side view of a driver/sensor assembly with an intermediary layer in accordance with an embodiment of the invention.

### DETAILED DESCRIPTION

The embodiments of the invention provide a method and apparatus for reducing the undesired transmission of vibration energy to and from electromechanical transducers used in middle ear implantable hearing aid systems, such as partial middle ear implantable (P-MEI), total middle ear implantable (T-MEI), or other hearing aid systems. A P-MEI or T-MEI hearing aid system assists the human auditory system in converting acoustic energy contained within sound waves into electrochemical signals delivered to the brain and interpreted as sound.

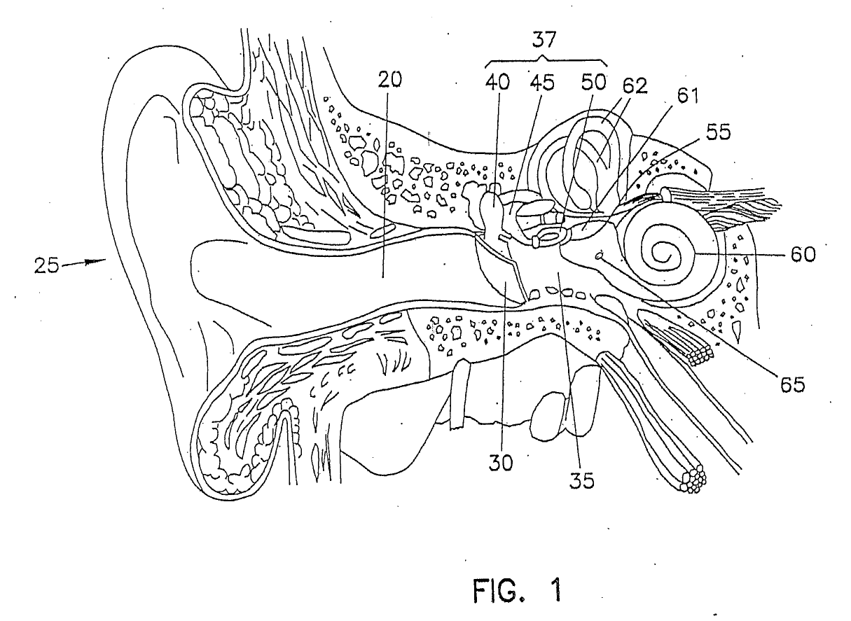

FIG. 1 illustrates, generally, the human auditory system. Sound waves are directed into an external auditory canal 20 by an outer ear (pinna) 25. The frequency characteristics of the sound waves are slightly modified by the resonant characteristics of the external auditory canal 20. These sound waves impinge upon the tympanic membrane (eardrum) 30, interposed at the terminus of the external auditory canal, between it and the tympanic cavity (middle ear) 35. Variations in the sound waves produce tympanic vibrations. The mechanical energy of the tympanic vibrations is communicated to the inner ear, including the cochlea 60, vestibule 61, and semicircular canals 62, by a sequence of articulating bones located in the middle ear 35. This sequence of articulating bones is referred to generally as the ossicular chain 37. Thus, the ossicular chain transforms acoustic energy at the eardrum to mechanical energy at the cochlea 60.

The ossicular chain 37 includes three primary components: a malleus 40, an incus 45, and a stapes 50. The malleus 40 includes manubrium and head portions. The manubrium of the malleus 40 attaches to the tympanic membrane 30. The head of the malleus 40 articulates with one end of the incus 45. The incus 45 normally couples mechanical energy from the vibrating malleus 40 to the stapes 50. The stapes 50 includes a capitulum portion, comprising a head and a neck, connected to a footplate portion by means of a support crus comprising two crura. The stapes 50 is disposed in and against a membrane-covered opening on the cochlea 60. This membrane-covered opening between the cochlea 60 and middle ear 35 is referred to as the oval window 55. Oval window 55 is considered part of cochlea 60 in this patent application. The incus 45 articulates the capitulum of the stapes 50 to complete the mechanical transmission path.

Normally, prior to implantation of the hearing aid system according to the embodiments of the invention, tympanic vibrations are mechanically conducted through the malleus 40, incus 45, and stapes 50, to the oval window 55. Vibrations at the oval window 55 are conducted into the fluid filled cochlea 60. These mechanical vibrations generate fluidic motion, thereby transmitting hydraulic energy within the cochlea 60. Pressures generated in the cochlea 60 by fluidic motion are accommodated by a second membrane-covered opening on the cochlea 60. This second membrane-covered opening between the cochlea 60 and middle ear 35 is referred to as the round window 65. Round window 65 is considered part of cochlea 60 in this patent application. Receptor cells in the cochlea 60 translate the fluidic motion into neural impulses which are transmitted to the brain and perceived as sound. However, various disorders of the tympanic membrane 30, ossicular chain 37, and/or cochlea 60 can disrupt or impair normal hearing.

Hearing loss due to damage in the cochlea is referred to as sensorineural hearing loss. Hearing loss due to an inability to conduct mechanical vibrations through the middle ear is referred to as conductive hearing loss. Some patients have an ossicular chain 37 lacking sufficient resiliency to transmit mechanical vibrations between the tympanic membrane 30 and the oval window 55. As a result, fluidic motion in the cochlea 60 is attenuated. Thus, receptor cells in the cochlea 60 do not receive adequate mechanical stimulation. Damaged elements of ossicular chain 37 may also interrupt transmission of mechanical vibrations between the tympanic membrane 30 and the oval window 55.

Implantable hearing aid systems have been developed, utilizing various approaches to compensate for hearing disorders. For example, cochlear implant techniques implement an inner ear hearing aid system. Cochlear implants electrically stimulate auditory nerve fibers within the cochlea 60. A typical cochlear implant system includes an external microphone, an external signal processor, and an external transmitter, as well as an implanted receiver and an implanted single channel or multichannel probe. In the more advanced multichannel cochlear implant, a signal processor converts speech signals transduced by the microphone into a series of sequential electrical pulses corresponding to different frequency bands within a speech frequency spectrum. Electrical pulses corresponding to low frequency sounds are delivered to electrodes that are more apical in the cochlea 60.

A particularly interesting class of hearing aid systems includes those which are configured for disposition principally within the middle ear 35 space. In middle ear implantable (MEI) hearing aids, an electrical-to-mechanical output transducer couples mechanical vibrations to the ossicular chain 37, which is optionally interrupted to allow coupling of the mechanical vibrations to the ossicular chain 37. Both electromagnetic and piezoelectric output transducers have been used to effect the mechanical vibrations upon the ossicular chain 37.

One example of a partial middle ear implantable (P-MEI) hearing aid system having an electromagnetic output transducer comprises: an external microphone transducing sound into electrical signals; external amplification and modulation circuitry; and an external radio frequency (RF) transmitter for transdermal RF communication of an electrical signal. An implanted receiver detects and rectifies the transmitted signal, driving an implanted coil in constant current mode. A resulting magnetic field from the implanted drive coil vibrates an implanted magnet that is permanently affixed only to the incus. Such electromagnetic output transducers have relatively high power consumption, which limits their usefulness in total middle ear implantable (T-MEI) hearing aid systems.

A piezoelectric output transducer is also capable of effecting mechanical vibrations to the ossicular chain 37. An example of such a device is disclosed in U.S. Pat. No. 4,729,366, issued to D. W. Schaefer on Mar. 8, 1988. In the '366 patent, a mechanical-to-electrical piezoelectric input transducer is associated with the malleus 40, transducing mechanical energy into an electrical signal, which is amplified and further processed. A resulting electrical signal is provided to an electrical-to-mechanical piezoelectric output transducer that generates a mechanical vibration coupled to an element of the ossicular chain 37 or to the oval window 55 or round window 65. In the '366 patent, the ossicular chain 37 is interrupted by removal of the incus 45. Removal of the incus 45 prevents the mechanical vibrations delivered by the piezoelectric output transducer from mechanically feeding back to the piezoelectric input transducer.

Piezoelectric output transducers have several advantages over electromagnetic output transducers. The smaller size or volume of the piezoelectric output transducer advantageously eases implantation into the middle ear 35. The lower power consumption of the piezoelectric output transducer is particularly attractive for T-MEI hearing aid systems, which include a limited longevity implanted battery as a power source.

A piezoelectric output transducer is typically implemented as a ceramic piezoelectric bi-element transducer, which is a cantilevered double plate ceramic element in which two opposing plates are bonded together such that they amplify a piezo electric action in a direction normal to the bonding plane. Such a bi-element transducer vibrates according to a potential difference applied between the two bonded plates. A proximal end of such a bi-element transducer is typically cantilevered from a transducer mount which is secured to a temporal bone within the middle ear. A distal end of such a bi-element transducer couples mechanical vibrations to an ossicular element such as stapes 50.

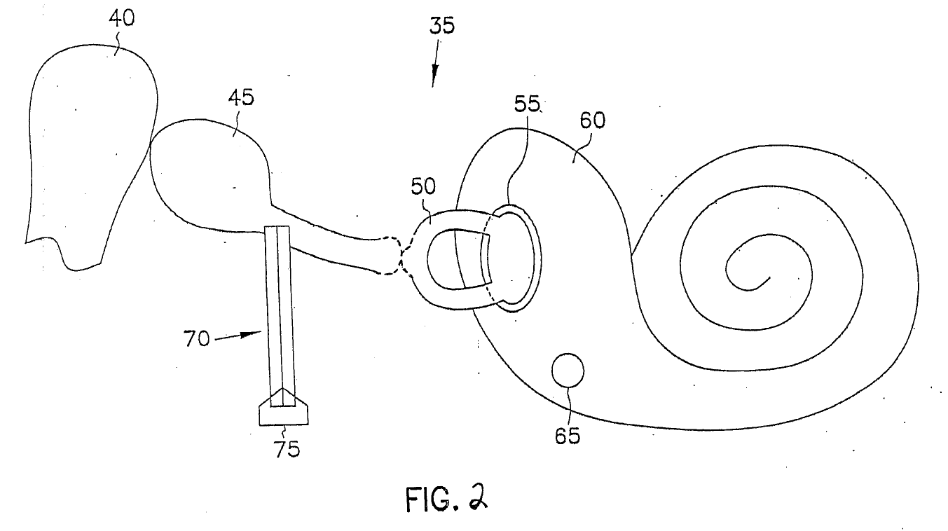

FIG. 2 is a generalized illustration of a transducer 70 cantilevered at its proximal end from a housing 75 mounted within a middle ear 35. A distal end of the transducer 70 is mechanically coupled to an auditory element to receive or effect mechanical vibrations when operating as an input or output transducer, respectively. For example, to receive mechanical vibrations as an input transducer, transducer 70 may be coupled to an auditory element such as a tympanic membrane 30, malleus 40, or incus 45. In another example, to effect vibrations as an output transducer, transducer 70 may be coupled to an auditory element such as incus 45, stapes 50, oval window 55, round window 65, vestibule 61, or semicircular canal 62. FIG. 2 also shows that incus 45 may be disarticulated from stapes 50 (indicated by dotted lines) in certain configurations.

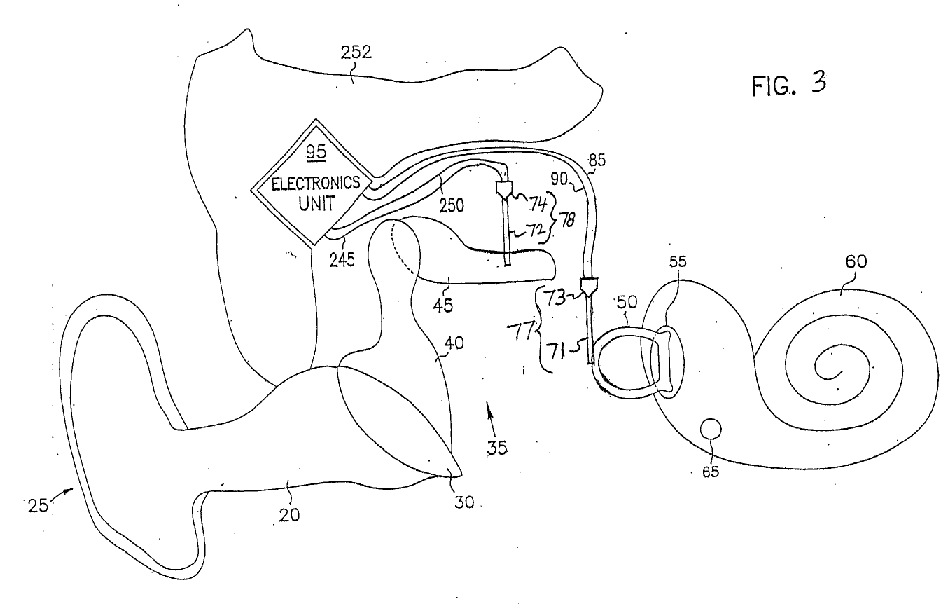

FIG. 3 illustrates generally a cross-sectional view of a T-MEI hearing aid system. An electromechanical output transducer 71 is mounted within middle ear 35 via housing 73, forming the driver assembly 77 portion of the T-MEI hearing aid system. Electromechanical output transducer 71 is coupled at its distal end to middle ear 35 only through an auditory element, preferably stapes 50, or alternatively incus 45, oval window 55, round window 65, vestibule 61, or semicircular canals 62. Electromechanical output transducer 71 is secured to stapes 50, for example, by any known attachment technique, including biocompatible adhesives or mechanical fasteners. The exact technique of attachment to the auditory element is not part of the invention.

Electronics unit 95 couples an electrical signal through lead wires 85 and 90 to any convenient respective connection points on housing 73. In response to electrical signals received from electronics unit 95, the electromechanical output transducer 71 generates and mechanically couples vibrations to stapes 50. The vibrations coupled to stapes 50 are in turn transmitted to cochlea 60 at oval window 55.

Also illustrated in FIG. 3 is an electromechanical input transducer 72. Electromechanical input transducer 72 is mounted within middle ear 35 via housing 74, forming the sensor assembly 78 portion of the T-MEI hearing aid system. Electromechanical input transducer 72 is coupled by any known attachment technique at its distal end, such as described above, to an auditory element such as malleus 40. Electromechanical input transducer 72 may also be secured to other auditory elements for receiving mechanical vibrations, such as incus 45 or tympanic membrane 30. As shown, vibrations of incus 45 at the distal end of electromechanical input transducer 72 cause vibratory displacements of the electromechanical input transducer 72. As a result, an electrical signal is generated and transmitted through respective lead wires 245 and 250 to electronics unit 95.

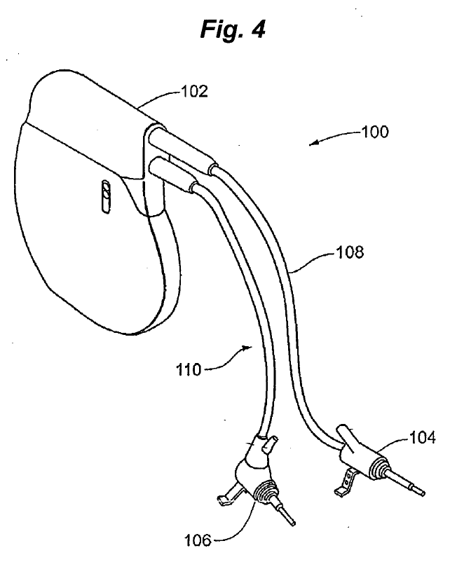

FIG. 4 is a perspective view of a hearing aid system 100 according to an embodiment of the invention. The hearing aid system 100 includes an electronics unit 102, a driver assembly 104 and a sensor assembly 106, the driver assembly 104 and sensor assembly 106 coupled to the electronics unit 102 via leads 108, 110 respectively. The hearing aid system 100 is intended to be completely implantable in a human being. In particular, the hearing aid system 100 is intended to help improve the hearing of human beings with mild to severe sensorineural hearing loss. The sensor assembly 106 is attached to the malleus and/or incus bone and the driver assembly 104 is attached to the stapes in the middle ear as will be described hereinafter. The electronics unit 102 is implanted in the skull preferably behind the ear. The electronics unit 102 includes a sound processor (not shown) and battery (not shown).

The hearing aid system 100 according to the preferred embodiments described herein, uses the ear drum as a microphone, picking up natural sounds through the ear canal. The sensor assembly 106 picks up vibrations from the eardrum and the malleus and/or incus bone and converts the vibrations into electrical signals which are sent to the electronics unit 102 via leads 110. The electronics unit 102 filters and amplifies the electrical signals and sends them to the driver assembly 104 via leads 108. The electronics unit 102 is capable of being programmed to customize it for the particular human being in which the hearing aid system 100 is implanted. The electronics unit 102 also houses a battery (not shown) to power the system.

The driver assembly 104 is coupled to the stapes 50. It converts electrical signals that it has received from the electronics unit 102 back into mechanical vibrations. The driver assembly 104 transmits these sound vibrations effectively to the stapes 50 and oval window 55.

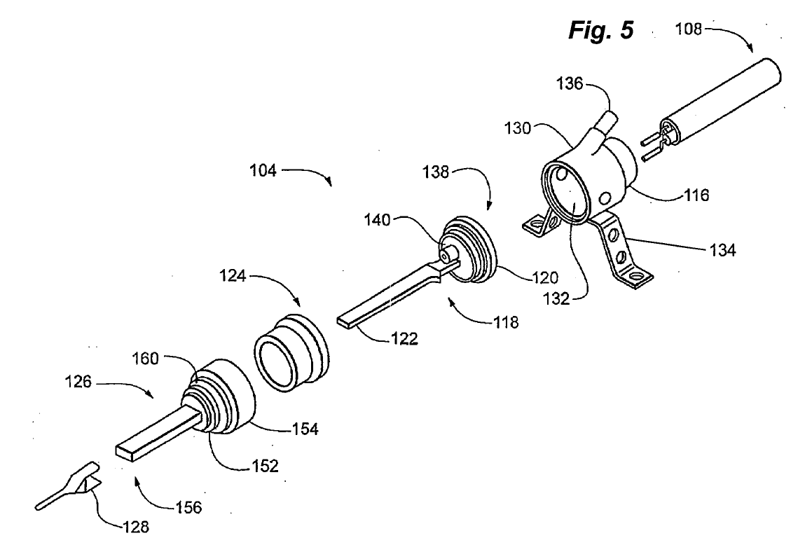

An example of a driver assembly is shown in a perspective, exploded view in FIG. 5. The driver assembly 104 includes a housing 116, a transducer assembly 118, a weld ring 124, a sheath 126 and a pin 128. The housing 116 is formed substantially by a cylindrical wall 130 with a lumen 132 extending therethrough. A pair of legs 134 extend from the outer surface of the cylindrical wall 130 to anchor the driver assembly 104 to the mastoid (not shown) of the human being. The legs 134 may be formed as part of the housing 116 or they may be separate members that are secured to the exterior of the housing, for example, by welding. An installation wire socket 136 extends into but not through the cylindrical wall 130 of the housing 116. The transducer assembly 118 includes a feed thru 120 and a transducer 122. The feed thru 120 has a pair of wires or leads 138 that extend therethrough. On one face of the feed thru 120 are projections 140 through which the leads 138 extend so that they can be electrically coupled to the transducer 122 by brazing, welding, or soldering, for example. The transducer 122 is secured to the feed thru 120 between these projections 140. The transducer 122 is secured to the feed thru 120 by gluing, bonding, soldering, brazing or welding, for example. In an embodiment, the transducer 122 may be a piezoelectric transducer that converts mechanical energy to electrical energy and vice versa, as is well known to those of ordinary skill in the art. The feed thru 120 is composed mainly of two parts, a ceramic disc 121 and a flange 123 encircling the ceramic disc 121.

The sheath 126 has a proximal end 154 and a distal end 156 coupled together by a longitudinal axis. The proximal end 154 is open and the distal end 156 may or may not be open. Extending between the proximal and distal ends 154, 156 is a lumen (not shown) that is dimensioned to house the transducer 122. The sheath has a longitudinal body that generally has a cross-section complementary to the transducer 122. Thus, depending on the shape of the transducer 122, the cross-section of the sheath 126 may be rectangular, square, or circular, for example.

The sensor assembly has a similar construction. For more detail regarding the driver and sensor assemblies, reference is made to U.S. Ser. No. 10/848,785, assigned to present assignee, which is hereby incorporated herein by reference.

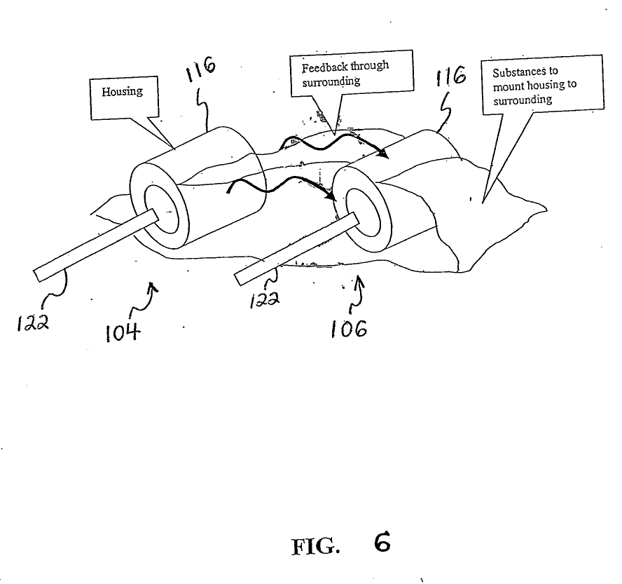

FIG. 6 is a schematic illustration of a driver and sensor assembly 104, 106, in a middle ear environment, showing the potential for feedback. Of course, it will be realized that not all of the components of the assemblies are shown. Vibration of the transducer 122 of driver assembly 104 in response to signals from electronics unit 102 may propagate to the housing 116 of driver assembly 104 due to the mechanical attachment of transducer 122 to housing 116. In turn, vibration from housing 116 of driver assembly 104 may propagate through the surrounding middle ear environment and be absorbed by housing 116 of sensor assembly 106 which, in turn, may mechanically couple these vibrations to transducer 122 of sensor assembly 106. The vibration signal is thereby converted to an electrical signal and sent to the electronics unit 102, completing the feedback loop.

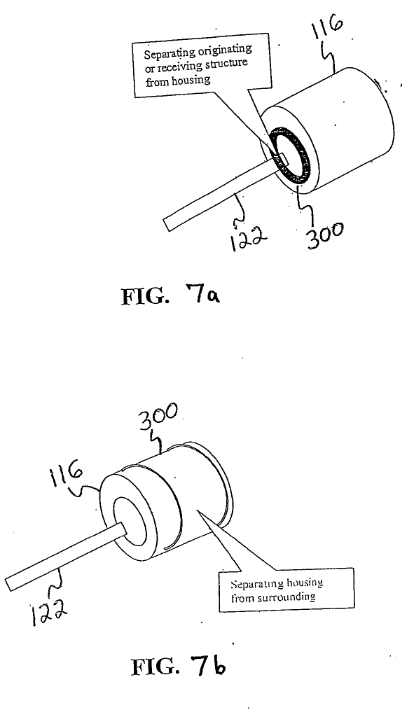

FIG. 7a is a perspective view of an embodiment of the invention wherein an intermediary layer 300 is installed between the transducer 122 and its housing 116. FIG. 7b shows an alternate embodiment of the invention wherein the intermediary layer 300 is installed between the housing 116 and the surrounding to which the housing 116 is installed. Of course, it will be realized that not all of the components of the assemblies are shown. The intermediary layer 300 may rely on the vibrational damping characteristics associated with a fluid substance, such as air, separating the transducer 122 from its housing 116, or the housing 116 from its surrounding structure, by means of a fluid-containing structure. For example, the intermediary layer 300 may be formed from an aerated medical adhesive. The aerated medical adhesive (or any other biocompatible polymer with elastic properties, i.e., foam) is designed to operate in an environment that has a lower pressure than the environment at which it was applied or in which it was aerated. This will cause the air bubbles throughout the layer of aerated medical adhesive to expand. Alternately, a biocompatible polymer with elastic properties (i.e., a foam) could be used to form the layer, wherein bubbles within the elastic matrix of the polymer would expand upon placement in an operating environment that is at a lower pressure than when formed. Bubble size and orientation can be controlled by varying curing time and low pressure conditions throughout the polymer curing process. The amount, size, and orientation of bubbles may also be controlled or influenced by varying the mesh size and pressures used during the formation of the polymer. Air bubble content in the applied mixture may, for example, be controlled by various agitation and aeration methods. The application process can leverage conventional techniques such as dip-coating, spray application and/or molding techniques. A combination of aeration and curing controls can be used to obtain the desired vibration damping characteristics.

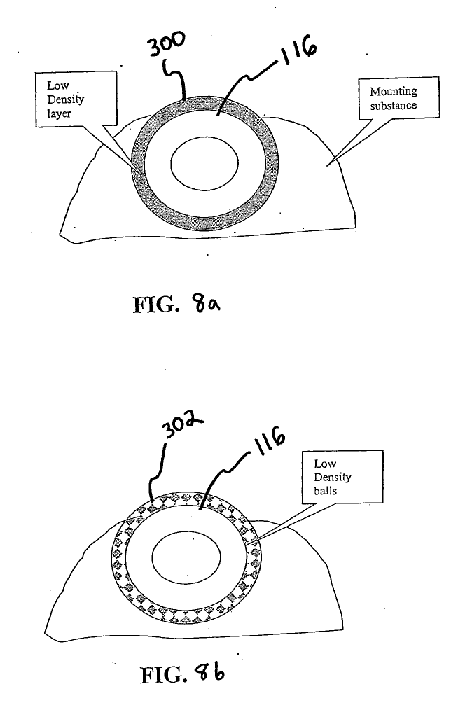

FIG. 8a illustrates another embodiment of the invention whereby biocompatible, spherical air-filled particles are applied to the outer surface of the housing 116 of the sensor and/or driver assemblies. These particles form an intermediary layer 300, as previously described, and may be either pre-attached to the housing 116 before mounting into the surrounding, or included in the substance that mounts the housing 116 to the surrounding. In the latter case, inclusion into the substance can be obtained before or at the time of application.

FIG. 8a also illustrates an embodiment of the invention whereby vibration damping can be obtained by aerating the substance that mounts the housing 116 to the surrounding. Aeration techniques considered are either mechanical, chemical or a combination thereof. Various process parameters control the desired amount and size of the air bubbles.

Various structures require vibrational damping across a broad frequency spectrum and/or at selective frequencies. The size, orientation and amount of air bubbles can have a frequency selective functionality. The physical properties of the matrix in which the air bubbles are enclosed, such as the elasticity, determines the frequency selective damping characteristics of the matrix.

FIG. 8b illustrates an embodiment of the invention whereby a low density polymer layer 302 may be attached to the outer surface of the housing 116. This layer may be a compressible solid layer or a layer containing multiple spherical balls of low density. Medical adhesive, polyurethane, or any other highly elastic biomedical material could be used to form this layer. Alternatively, the low density material in an embodiment of the invention may be a biodegradable substance with elastic properties. At the time of surgery, an elastic coating or layer of bio-replaceable material may be attached to the transducer housing. This layer may provide vibrational damping between the transducer and the surrounding or between the surrounding and the driver or sensor assembly. Throughout the post-operative healing period, the biodegradable layer may be gradually replaced by fibrotic tissue comprised of similar elastic properties as the initial layer. Materials that are well suited for this purpose are hydrogels. The addition of inflammatory reactants to the hydrogel material will affect the density of the fibrotic layer replacing the hydrogel and thereby impact the damping characteristics.

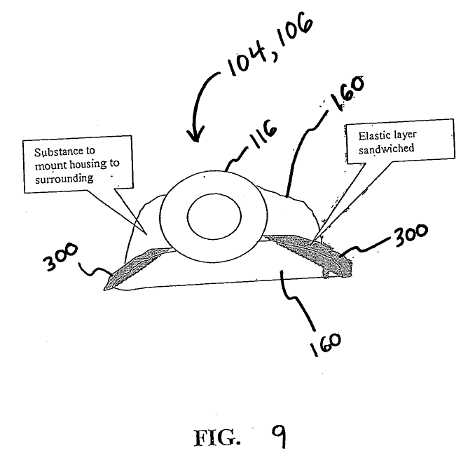

FIG. 9 illustrates another possible embodiment of the invention whereby vibration damping is provided between the driver assembly 104 (or sensor assembly 106) and its surroundings by a multi-layer mounting technique that contains material having elastic properties positioned between at least one layer of an adhesive mounting substance 160 and the driver and/or sensor assembly 104, 106. The invention is not confined to a single layer but can consist of multiple layers within the mounting construction.

In an embodiment of the invention, the lower part of the mounting substance is used to accomplish initial geometrical positioning of the housing 116 within its surroundings. The intermediary layer 300, or damping layer, is subsequently applied over the mounting substance. Thereafter, the remaining portion of the housing 116 is mounted on top of the intermediary layer 300, thereby separating the main portion of the housing 116 from the surrounding by an elastic damping material. The intermediary layer 300 and mounting substance may be chosen to provide proper adhesion characteristics and to thereby maintain the positioning of the driver and/or sensor assembly 104, 106 within the middle ear.

In another embodiment to reduce the transmission of vibrational energy into the surrounding, a damping mass (not shown) may be attached to the housing 116 of the driver and/or sensor assembly 104, 106. Alternatively, changing the mass relationship between the housing 116 and the driver and/or sensor assembly 104, 106 so that the housing 116 mass far exceeds the mass of the transducer 122 may accomplish a similar result. Increasing the mass of the housing 116 in relationship to the transducer 122 significantly reduces the vibrational energy that can be coupled to the surrounding. By adding mass to the housing 116, either by means of attaching mass or increasing the mass of the housing 116 construction, the ability to transfer vibrational energy to the surrounding is reduced. This results in vibrational damping between a transducer 122 and its associated housing 116 within the middle ear.

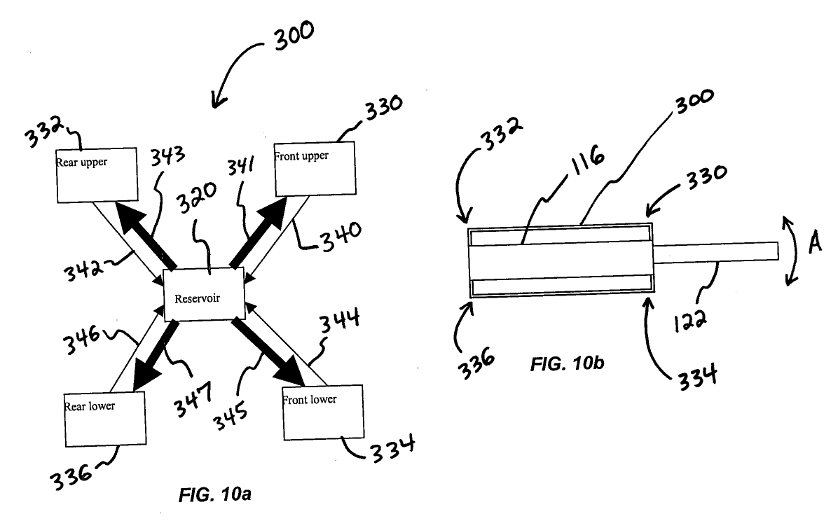

As described above with reference to FIGS. 7a and 7b, certain embodiments of the invention may have an intermediary layer 300 installed either between the transducer 122 and its housing 116, or between the housing 116 and its surroundings. The intermediary layer 300 may rely on the vibration damping characteristics associated with a fluid substance by means of a fluid-containing structure. In one possible embodiment of the invention, the intermediary layer 300 may form a fluid-containing structure similar to that shown in FIGS. 10a and 10b and described below. As used throughout the specification and claims, the term “fluid” is intended to encompass both liquid and gaseous materials, for example, oil and air, respectively.

FIG. 10a is a schematic diagram of an intermediary layer 300 according to an embodiment of the invention. The intermediary layer 300 forms a conduit through which a fluid substance (gas or liquid) can move between a number of segments within the intermediary layer 300 (i.e., chambers 330, 332, 334, 336) to absorb energy and thereby dampen vibrations. The intermediary layer 300 may, for example, be a polymer with a plurality of flowpaths formed to link the chambers 330, 332, 334, 336 to a reservoir 320, and to facilitate fluid communication between the chambers and the reservoir. The flow paths may provide for a different rate of flow toward the chambers than toward the reservoir. For example, a relatively slow flow of fluids or air from a chamber into the reservoir 320 (indicated by the thin arrows 340, 342, 344, and 346) may be provided by a narrow flow path, or by placing a restriction in the flow path, for example. A relatively large flow of fluids or air from the reservoir 320 into the chambers (indicated by the thick arrows 341, 343, 345, and 347) may be provided by a larger or less restricted flow path, for example. In certain embodiments, it may be possible for a single flow path to allow flow in both directions, with different rates of flow depending on the direction of flow. For example, a “check valve” type of configuration may be employed to allow more flow in one direction than the other.

As shown in FIG. 10b, the transducer 122 may be displaced upwardly and downwardly as indicated by “A.” When the tip of transducer 122 is displaced upward, for example, a reactive force is exerted on the transducer assembly and housing 116 in such a way that compressive forces are exerted on the fluids in the front upper chamber 330 and the rear lower chamber 336. Fluid in chambers 330 and 336 will be moved toward the reservoir through relatively narrow or restricted flow paths 340 and 346. The reservoir 320 may then supply fluid to the rear upper chamber 332 and the front lower chamber 334 through the relatively large, unrestricted flow paths 343 and 345. This displacement of fluids (and/or air) through one or more paths in the intermediary layer 300 causes energy to be absorbed, which energy may otherwise be manifested as vibrational energy in the housing 116. In embodiments where the intermediary layer 300 has a plurality of flow paths as described above, the intermediary layer 300 may be formed of a polymeric substance having visco-elastic properties.

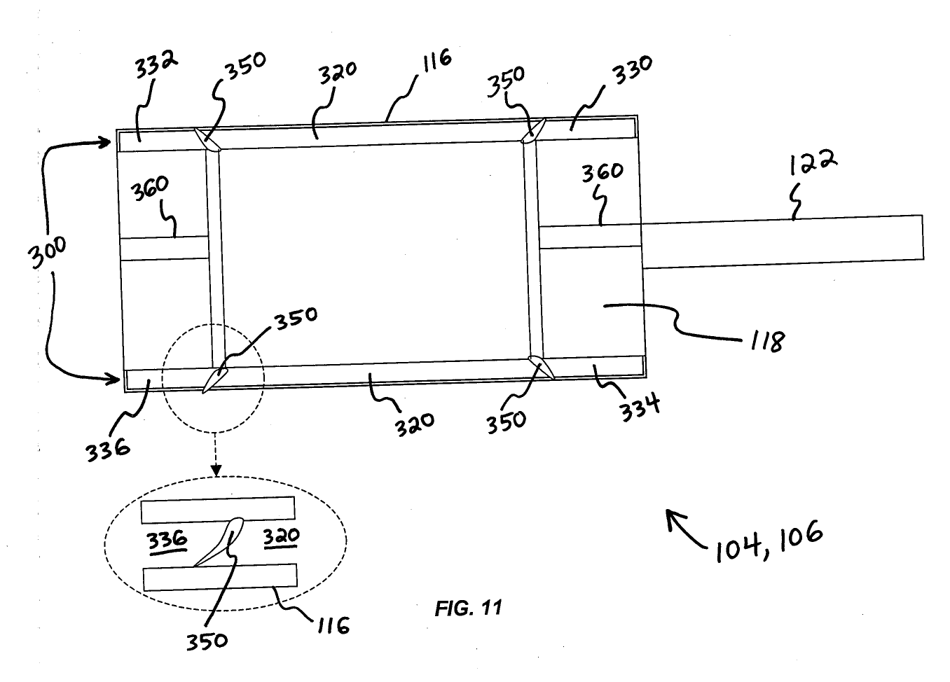

FIG. 11 shows one possible embodiment of the invention having a plurality of flowpaths. A driver/sensor assembly 104, 106 is shown having an intermediary layer 300 formed between the transducer assembly 118 and the housing 116. The intermediary layer 300 is comprised of a plurality of chambers 330, 332, 334, and 336, as well as reservoir 320, with each of the chambers being at least partially in fluid communication with reservoir 320. In certain embodiments of the invention, the intermediary layer 300 further comprises seal elements 350 arranged to form boundaries between each of the chambers and the reservoir 320. The seal elements 350 may be formed to allow a fluid or air to flow relatively easily from the reservoir 320 to a chamber, while restricting the flow of a fluid or air from a chamber into the reservoir 320. This may be accomplished by choosing a shape and arrangement of seal element 350 that is similar to that illustrated in FIG. 11, for example. The restriction on flow provided by seal element 350 may be further influenced by varying such parameters as the surface roughness of housing 116 where seal element 350 comes into contact, or by altering the shape or curvature or size of seal element 350, or by forming one or more orifices in seal element 350, for example.

In certain embodiments of the invention, the seal element 350 forms a seal that extends substantially around the circumference of the transducer assembly 118 and the housing 116. A block seal 360 may be formed to separate the front upper and lower chambers 330, 334 from being in fluid communication with each other; similarly, a block seal 360 may also be formed to separate the rear upper and lower chambers 332, 336 from being in fluid communication with each other. As would appreciated by one of ordinary skill in the art having the benefit of these teachings, a different number of chambers and/or reservoirs may be employed to accomplish vibration damping via the movement of fluids or air through a plurality of flowpaths; such modifications are contemplated and are considered to fall within the scope of the claimed invention.

Throughout the description of the various embodiments, references are made to materials with various elastic and visco-elastic properties. The specific choice of materials used to form the intermediary layer 300 may be made by one having skill in the art to accomplish frequency-specific damping and other intrinsic elastic properties. Furthermore, it is understood that suitable elastic materials relying on air inclusion as a means of damping are close cell matrices and have limited or no permeability to bodily fluids. These are intrinsic properties of the material itself or can be obtained by a secondary process applied to the material, for example, by the application of an impermeable coating or impregnation of the elastic material by substances such as parylene. The transducer assemblies according to the embodiments described herein may be hermetically sealed to provide a fully implantable device.

Thus, embodiments of a METHOD AND APPARATUS FOR VIBRATIONAL DAMPING OF IMPLANTABLE HEARING AID COMPONENTS are disclosed. The embodiments described above are for exemplary purposes only and are not intended to limit the scope of the embodiments of the claimed invention. Various modifications and extensions of the described embodiments will be apparent to those skilled in the art and are intended to be within the scope of the invention.

What is claimed is:

1. A driver/sensor assembly for a middle ear implantable hearing aid system, the driver/sensor assembly comprising:
a transducer assembly having a proximal end and a distal end;
a housing disposed adjacent the proximal end of the transducer assembly, the housing adapted to be mounted within a middle ear space; and
a first intermediary layer disposed between the transducer assembly and the housing to couple the housing to the transducer assembly and provide vibrational damping therebetween, the first intermediary layer comprising a vibration damping structure.

2. The driver/sensor assembly of claim 1 further comprising a second intermediary layer disposed on an outer surface of the housing to provide vibrational damping between the housing and the middle ear space, the second intermediary layer comprising a vibration damping structure.

3. The driver/sensor assembly of claim 2 wherein the transducer assembly is a driver adapted to receive an electrical signal and configured to deliver vibrations to an ossicular element of a middle ear.

4. The driver/sensor assembly of claim 2 wherein the transducer assembly is a sensor adapted to receive mechanical vibrations from an auditory element and configured to generate an electrical signal.

5. The driver/sensor assembly of claim 1 wherein the intermediary layer is formed of an aerated medical adhesive.

6. The driver/sensor assembly of claim 1 wherein the intermediary layer is formed of an elastic biocompatible polymer.

7. The driver/sensor assembly of claim 1 wherein the first intermediary layer is formed of a low density polymer.

8. The driver/sensor assembly of claim 7 wherein the low density polymer is a compressible solid.

9. The driver/sensor assembly of claim 7 wherein the low density polymer comprises a plurality of generally spherical elastic balls.

10. The driver/sensor assembly of claim 1 further comprising a damping mass operatively coupled to the housing.

11. The driver/sensor assembly of claim 1 wherein the vibration damping structure comprises a plurality of flow paths adapted to move a fluid to absorb mechanical energy.

12. The driver/sensor assembly of claim 11 wherein the vibration damping structure further comprises a reservoir, and a plurality of chambers adapted to contain a fluid, at least one chamber being in at least partial fluid communication with the reservoir via one or more of the flow paths.

13. The driver/sensor assembly of claim 12 wherein at least one chamber is adapted to respond to a compressive force by moving a fluid contained therein to the reservoir via a flow path.

14. The driver/sensor assembly of claim 12 wherein the plurality of chambers includes front upper, front lower, rear upper, and rear lower chambers.

15. The driver/sensor assembly of claim 12 further comprising at least one seal element disposed in a flow path between a chamber and the reservoir, the seal element being adapted to cause a greater restriction of fluid flow from the chamber to the reservoir than from the reservoir to the chamber.

16. A driver/sensor assembly for a middle ear implantable hearing aid system, the driver/sensor assembly comprising:
a transducer assembly having a proximal end and a distal end;
a housing coupled to the proximal end of the transducer assembly, the housing adapted to be mounted within a middle ear space; and
a first intermediary layer disposed on an outer surface of the housing to provide vibrational damping between the housing and the middle ear space, the first intermediary layer comprising a vibration damping structure.

17. The driver/sensor assembly of claim 16 wherein the first intermediary layer comprises at least one layer of a material having elastic damping properties and at least one layer of an adhesive substance.

18. The driver/sensor assembly of claim 16 wherein the first intermediary layer is a low density polymer.

19. The driver/sensor assembly of claim 18 wherein the low density polymer is a compressible solid.

20. The driver/sensor assembly of claim 18 wherein the low density polymer comprises a plurality of generally spherical elastic balls.

21. The driver/sensor assembly of claim 18 wherein the low density polymer is a hydrogel material.

22. The driver/sensor assembly of claim 21 wherein an inflammatory reactant has been added to the hydrogel material.

23. The driver/sensor assembly of claim 16 further comprising a damping mass operatively coupled to the housing.

24. The driver/sensor assembly of claim 16 wherein the intermediary layer is formed of an aerated medical adhesive.

25. The driver/sensor assembly of claim 16 wherein the intermediary layer is formed of an elastic biocompatible polymer.

26. The driver/sensor assembly of claim 16 further comprising a mounting bracket adapted for attachment to a temporal bone, the mounting bracket coupled to the housing with the first intermediary layer disposed therebetween.

27. The driver/sensor assembly of claim 16 wherein the vibration damping structure comprises a plurality of flow paths adapted to move a fluid to absorb mechanical energy.

28. The driver/sensor assembly of claim 27 wherein the vibration damping structure further comprises a reservoir, and a plurality of chambers adapted to contain a fluid, at least one chamber being in at least partial fluid communication with the reservoir via one or more of the flow paths.

29. The driver/sensor assembly of claim 28 wherein at least one chamber is adapted to respond to a compressive force by moving a fluid contained therein to the reservoir via a flow path.

30. The driver/sensor assembly of claim 28 wherein the plurality of chambers includes front upper, front lower, rear upper, and rear lower chambers.

31. The driver/sensor assembly of claim 28 further comprising at least one seal element disposed in a flow path between a chamber and the reservoir, the seal element being adapted to cause a greater restriction of fluid flow from the chamber to the reservoir than from the reservoir to the chamber.

32. A method of reducing vibrations in a middle ear implantable hearing aid system having transducer assemblies mounted within a middle ear space, the method comprising:
providing a transducer assembly;
providing a housing to support the transducer assembly, the housing adapted to be mounted within a middle ear space; and
forming an intermediary layer on a portion of the housing to provide vibrational damping, the intermediary layer comprising a vibration damping structure.

33. The method of claim 32 wherein the intermediary layer is disposed between the transducer assembly and the housing to couple the housing to the transducer assembly and provide vibrational damping therebetween.

34. The method of claim 32 wherein the intermediary layer is disposed on an outer surface of the housing to provide vibrational damping between the housing and the middle ear space.

35. The method of claim 34 wherein the intermediary layer is formed on an outer surface of the housing prior to mounting the housing in the middle ear space.

36. The method of claim 34 wherein the intermediary layer is formed on an outer surface of the housing during mounting of the housing in the middle ear space.

37. The method of claim 32 wherein the intermediary layer is an aerated material.

38. The method of claim 37 wherein the intermediary layer is an aerated medical adhesive.

39. The method of claim 37 wherein the aerated material is formed using a chemical process.

40. The method of claim 37 wherein the aerated material is formed using a mechanical process.

41. The method of claim 37 wherein the intermediary layer has an elasticity which may be varied to change the frequency response of the vibration damping.

42. The method of claim 41 wherein the elasticity of the intermediary layer may be varied by changing one or more characteristics of the vibration damping structure selected from the group consisting of size, orientation, and amount of air in the aerated material.

43. The method of claim 37 wherein the intermediary layer provides a frequency selective damping response that may be adjusted by varying one or more characteristics of the vibration damping structure selected from the group consisting of size, orientation, and amount of air in the aerated material.

44. The method of claim 43 wherein the intermediary layer is adapted to dampen vibrational energy over a range of frequencies including a resonant frequency of the transducer assembly and housing.

45. A middle ear implantable hearing aid system comprising:
a driver assembly having
a driver transducer assembly having a proximal end and a distal end, the transducer assembly adapted to convert electrical energy to mechanical energy, and
a driver housing disposed adjacent the proximal end of the driver transducer assembly, the driver housing adapted to be mounted within a middle ear space;
a sensor assembly having
a sensor transducer assembly having a proximal end and a distal end, the sensor transducer assembly adapted to convert mechanical energy to electrical energy, and
a sensor housing disposed adjacent the proximal end of the sensor transducer assembly, the sensor housing adapted to be mounted within a middle ear space;
an electronics unit having
a sound processor and a battery, the sound processor adapted to filter and amplify signals from the sensor assembly and provide said signals to the driver assembly; and
leads coupling the driver and sensor assemblies to the electronics unit,
wherein an intermediary layer is disposed on at least one of the sensor housing and driver housing to provide vibrational damping, the intermediary layer comprising a vibration damping structure.

46. The middle ear implantable hearing aid system of claim 45 wherein the intermediary layer is disposed between the transducer assembly and the housing of at least one of the sensor and driver assemblies.

47. The middle ear implantable hearing aid system of claim 45 wherein the intermediary layer is disposed on an outer surface of the housing of at least one of the sensor and driver assemblies.
